(19) United States
(12) Patent Application Publication
(10) Pub. No.: US 2017/0157715 A1
(43) Pub. Date: Jun. 8, 2017

(54) Brazing Ring with Spikes and Method for Securing a Brazing Ring to a Tube

(71) Applicant: Bellman-Melcor Development, LLC, Tinley Park, IL (US)

(72) Inventor: Steven Campbell, Mokena, IL (US)

(21) Appl. No.: 15/352,204

(22) Filed: Nov. 15, 2016

Related U.S. Application Data
(60) Provisional application No. 62/262,134, filed on Dec. 2, 2015.

(51) Int. Cl. B23K 35/02; B23K 35/365; B23K 20/02; B21F 37/00

(52) U.S. Cl. CPC B23K 35/0222; B21F 37/00; B23K 35/365; B23K 20/02; F16L 13/08

(57) ABSTRACT

A brazing ring having inwardly directed spikes is secured to an end of a tube prior to a brazing operation.

### CROSS-REFERENCE TO RELATED APPLICATIONS

The present application claims the benefit of U.S. Provisional Patent Application No. 62/262,134, filed Dec. 2, 2015, the contents of which are incorporated herein by reference.

### FEDERALLY SPONSORED RESEARCH OR DEVELOPMENT

N/A

### FIELD OF THE INVENTION

The present invention generally relates to a brazing ring having inwardly directed projections or spikes, a method and apparatus for forming the brazing ring, and a method for securing the brazing ring to a tube so that the ring does not fall off the tube prior to a brazing operation.

### BACKGROUND OF THE INVENTION

Return bends and other tubing for industrial use (e.g., automotive, air conditioning and refrigerating systems) are typically connected to other components of a system in a brazing operation. A brazing material—typically in the form of a ring having an open end with a small gap—is melted where the bend or tube connects to the system to provide a sealed joint. A flux is typically utilized in this operation and can be held by the brazing material.

Brazing rings are typically loaded onto return bends prior to transit of the return bends to the system. The brazing rings are formed having a smaller diameter than the ends of the return bends and thus are slightly expanded when placed on the ends. While this expansion provides a mechanical mechanism (e.g., tension) for holding onto the ends of the return bend, other factors, such as time, environmental conditions, jarring during transit, etc. can cause the tension holding the brazing rings to soften and allow the rings to fall off.

The present invention provides an improved brazing ring and method and apparatus for forming the brazing ring, and a method of securing the brazing ring onto the return bend to avoid loss during transit.

### SUMMARY OF THE INVENTION

The present invention provides a brazing ring having a plurality of inwardly directed projections or spikes positioned about an inner circumference of the ring. The inwardly directed projections help secure the ring to the end. This allows for safe transport of the return bend loaded with brazing rings without concern that the brazing rings will fall off during transit.

In accordance with one aspect of the invention, a brazing ring comprises a circular brazing material having an inner circumference, and a plurality of inwardly directed projections extending from the inner circumference of the brazing material for securing the ring to a bend. The brazing ring can include a flux.

The plurality of radially inwardly directed projections can be equally spaced about an inner circumference of the ring and can have a generally triangular cross-sectional shape. Each of the projections can extend inwardly from the inner circumference approximately 0.004 inches.

The brazing ring can be formed from a piece of a brazing wire having a first end and a second end. The ring can include a slight gap between the first end and the second end of the brazing wire forming the ring.

In accordance with another aspect of the invention, a method of forming a brazing ring is provided. The method comprises providing a piece of wire formed from a brazing material and wrapping the piece of brazing wire into a ring shape about a cylindrical post. The post is formed to have a plurality of grooves about an outer circumference. The method further includes compressing material from an inner circumference of the ring shaped brazing material into the grooves on the post to form radially inwardly extending projections. The step of providing a piece of wire formed from a brazing material includes the steps of providing a brazing metal and providing a flux.

In accordance with yet another aspect of the invention, an apparatus for forming a brazing ring having inwardly projecting extensions is provided. The apparatus comprises a cylindrical post having a plurality of grooves about an outer circumference of the post. The plurality of grooves can have a generally triangular cross-sectional shape. Each of the plurality of grooves can be approximately 0.004 inches deep and can be spaced equally about the circumference of the post.

In accordance with yet another aspect of the invention, a method of securing a brazing ring to an end of tube is provided. The method comprises providing a brazing ring having a plurality of inwardly extending projections about an inner circumference of the brazing ring, positioning the brazing ring about an end of a tube, and applying a radially inwardly directed compressive force to an outer circumference of the brazing ring

The tube can be part of a return bend. The return bend includes a second end portion. Accordingly, a second brazing ring having a plurality of inwardly extending projections can be secured about the second end portion of the tube in a like manner.

Further aspects of the invention are disclosed in the Figures, and are described herein.

### BRIEF DESCRIPTION OF THE DRAWINGS

To understand the present invention, it will now be described by way of example, with reference to the accompanying drawings in which:

FIG. 1 is a perspective view of two brazing rings of the present invention on both ends of a return bend;

FIG. 2 is a top view of a brazing ring having inwardly directed projections or spikes in accordance with an aspect of the present invention;

FIG. 3 is a perspective view of a ring forming device;

FIG. 4 is a perspective view of a king post in the ring forming device of FIG. 3;

FIG. 5 is a perspective view of a king post for use in the ring forming device of FIG. 3;

FIG. 6 is a close-up view of the king post of FIG. 5 showing a plurality of grooves around the outer surface of a portion of the king post;

FIG. 7 is a cross-sectional view of the king post through the grooves; and,

FIG. 8 is an enlarged cross-sectional view of one of the plurality of grooves of FIG. 7.

### DETAILED DESCRIPTION

While this invention is susceptible of embodiments in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

The present invention is directed to a brazing ring that can be secured to a tube, such as an end of a return bend during transit (i.e., prior to a brazing operation), a method and apparatus for forming the brazing ring, and a method for securing the brazing ring to the return bend.

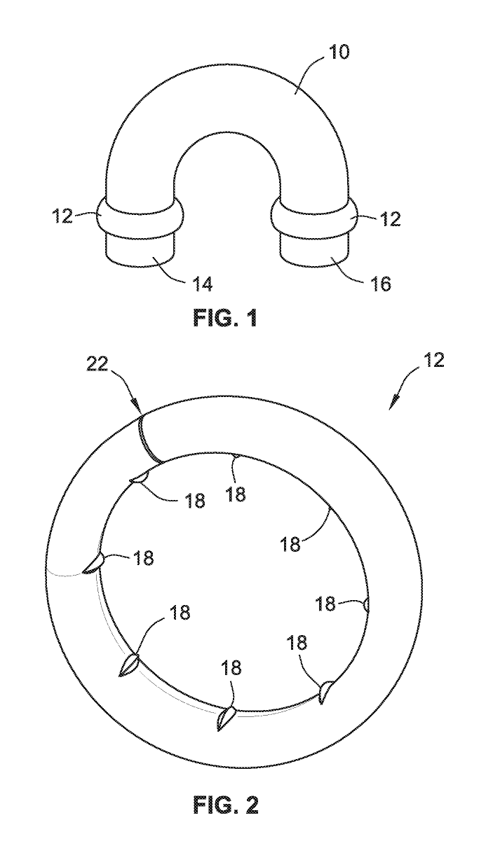

FIG. 1 shows a typical return bend 10 (i.e., a generally U-shaped piece of tubing that connects to two parallel tubes of a system, such as an air conditioning system), with a first brazing ring 12 on a first end 14 of one leg of the return bend 10, and a second brazing ring 12 on a second end 16 of the other leg of the return bend 10.

To facilitate installation, brazing rings are typically placed on the ends prior to transporting the ends to remote systems. As discussed below, the brazing rings 12 include structure to secure the brazing rings 12 to the ends 14, 16 of the return bend 10 so that they do not fall off during transit.

The brazing ring 12 is initially formed from a wire of material bent into a circular shape. This leaves a slight opening 22 between the ends of the ring 12. The brazing rings 12 can be formed from a variety of different metals or alloys and can include a flux. A brazing ring of the type disclosed in U.S. Pat. No. 9,095,937 (which is incorporated herein by reference), for example, can be utilized in this embodiment of the invention.

Referring to FIG. 2, a brazing ring 12 made in accordance with the present invention is shown. The brazing ring 12 is formed to include a plurality of radially inwardly extending projections or spikes 18. The radially inwardly extending projections 18 are utilized to secure the brazing ring 12 to the ends 14, 16 of the bend 10 (or to the end of any other similar object or structure). The projections 18 help the brazing ring 12 stay on the end during transport, prior to a brazing operation.

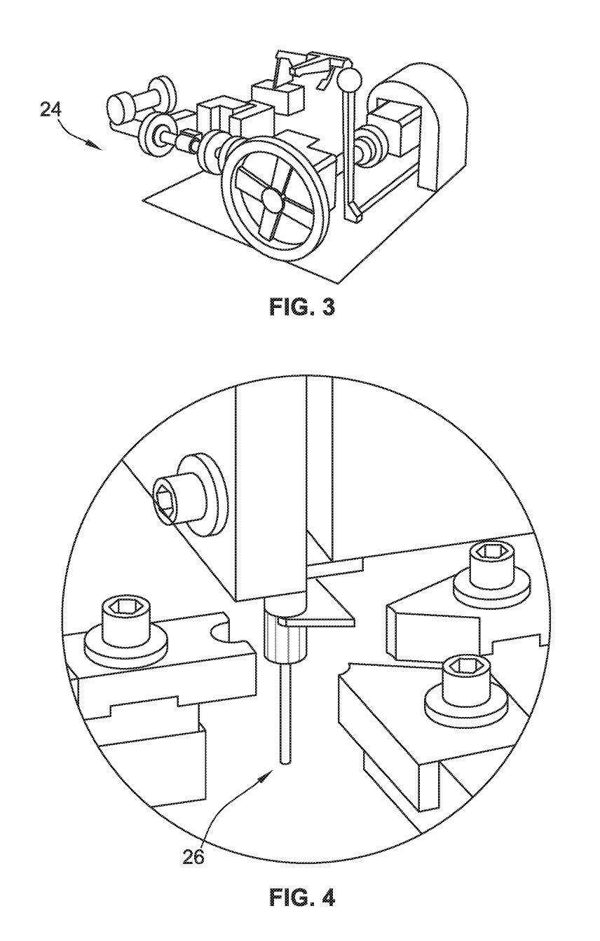

The projections 18 of the brazing ring 12 are formed using a grooved king post of a ring forming apparatus. FIG. 3 provides a perspective view of one ring forming apparatus 24 that can be utilized. A brazing wire is wrapped around a king post 26 of the apparatus 24 to form it into a ring shape. The king post 26 is shown in the apparatus 24 in FIG. 4.

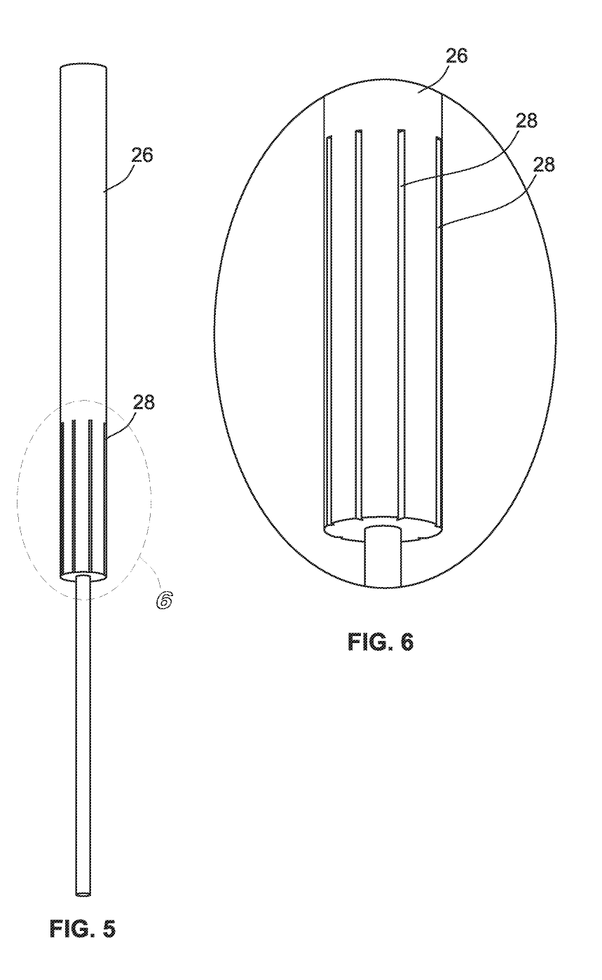

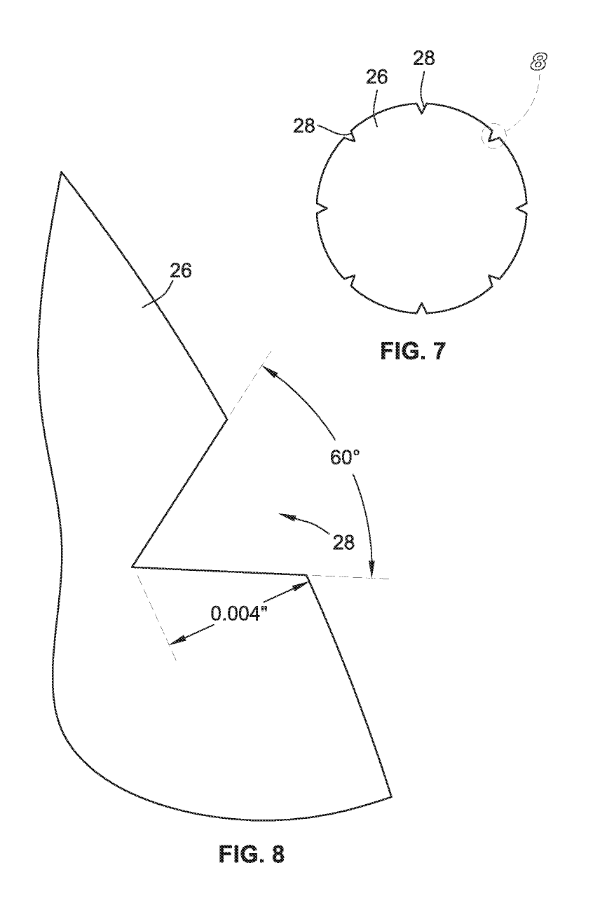

To create the projections 18 in the brazing ring 12, the king post 26 is provided with a plurality of grooves 28 about the circumference of king post 26 as illustrated in FIGS. 5-6 and the cross-sectional views of FIGS. 7-8.

To form the brazing ring 12, the brazing wire is wrapped around and compressed against the king post 26. This forces material from the brazing wire into the grooves 28 formed around the king post 26 to create the radially inwardly extending projections 18.

To secure a brazing ring 12 to an end of the return bend 10, it is placed on the bend and then compressed again. This enables the projections 18 to hold onto the end.

As illustrated in FIGS. 7 and 8, the grooves 28 have a generally triangular cross-sectional shape. The triangular cross-sections of the grooves 28 form pointed projections 18 on the brazing ring 12. Other groove cross-sectional shapes (e.g., rectangular), which will form correspondingly shaped projections, can also be used. Preferably, each groove 28 has a depth of approximately 0.004 inches.

While the brazing rings 12 of the Detailed Description are shown as circular, other shapes corresponding to the cross-sectional shape of a tube requiring brazing can be utilized (e.g., an oval shape).

Many modifications and variations of the present invention are possible in light of the above teachings. It is, therefore, to be understood within the scope of the appended claims the invention may be protected otherwise than as specifically described. I/We claim:

1. A brazing ring comprising:
a circular brazing material having an inner circumference;
a plurality of inwardly directed projections extending from the inner circumference of the brazing material for securing the ring to a bend.

2. The brazing ring of claim 1 further comprising a flux.

3. The brazing ring of claim 1 wherein the plurality of radially inwardly directed projections are equally spaced about an inner circumference of the ring.

4. The brazing ring of claim 1 wherein the ring is formed from a piece of a brazing wire having a first end and a second end.

5. The brazing ring of claim 4 wherein the ring includes a slight gap between the first end and the second end of the brazing wire forming the ring.

6. The brazing ring of claim 1 wherein each of the plurality of inwardly extending projections have a generally triangular cross-sectional shape.

7. The brazing ring of claim 1 wherein each of the projections extend inwardly from the inner circumference of the ring approximately 0.004 inches.

8. The brazing ring of claim 2 wherein the flux is confined within a channel of the brazing material.

9. A method of forming a brazing ring comprising:
providing a piece of brazing wire formed from a brazing material;
wrapping the piece of brazing wire into a ring shape about a cylindrical post, the post having a plurality of grooves about an outer circumference; and,
compressing material from an inner circumference of the ring shaped brazing material into the grooves on the post to form radially inwardly extending projections.

10. The method of claim 9 wherein the step of providing a piece of wire formed from a brazing material includes the steps of providing a brazing metal and providing a flux with the brazing metal.

11. The method of claim 9 wherein the grooves of the cylindrical post are spaced equidistantly about the post.

12. The method of claim 11 wherein each of the plurality of grooves has a generally triangular cross-sectional shape.

13. The method of claim 12 wherein each of the plurality of grooves is approximately 0.004 inches deep.

14. The apparatus of claim 11 wherein each of the plurality of grooves has a generally rectangular cross-sectional shape.

15. A method of securing a brazing ring to an end of a tube comprising:
providing a first brazing ring having a plurality of inwardly extending projections about an inner circumference of the first brazing ring;
positioning the first brazing ring about a first end of a tube; and,
applying a radially inwardly directed compressive force to an outer circumference of the first brazing ring.

16. The method of claim 15 further comprising:
providing a second brazing ring having a plurality of inwardly extending projections about an inner circumference of the second brazing ring;
positioning the second brazing ring about a second end of the tube; and,
applying a radially inwardly directed compressive force to an outer circumference of the second brazing ring.

17. The method of claim 16 wherein the tube is a generally U-shaped bend.

18. The method of claim 15 wherein the step of providing a first brazing ring having a plurality of inwardly extending projections about an inner circumference of the first brazing ring comprises:
providing a piece of brazing wire formed from a brazing material;
wrapping the piece of brazing wire into a ring shape about a cylindrical post, the post having a plurality of grooves about an outer circumference; and,
compressing material from an inner circumference of the ring shaped brazing material into the grooves on the post to form radially inwardly extending projections.

19. The method of claim 18 wherein the step of providing a piece of wire formed from a brazing material includes the steps of providing a brazing metal and providing a flux with the brazing metal.

20. The method of claim 15 wherein each of the plurality of grooves has a generally triangular cross-sectional shape.
